(19) United States
(12) Patent Application Publication
(10) Pub. No.: US 2026/0307280 A1
(43) Pub. Date: Oct. 8, 2026

(54) MULTI-FUNCTION TOOL

(71) Applicant: Alexandra Acimovic, Edmonton (CA)

(72) Inventor: Alexandra Acimovic, Edmonton (CA)

(21) Appl. No.: 19/170,017

(22) Filed: Apr. 3, 2025

(51) Int. Cl. B26B 11/00

(52) U.S. Cl. CPC B26B 11/001

(57) ABSTRACT

A multi-function tool that is configured to assist a user in the execution of a plurality of tasks wherein the device includes three hingedly secured elements. The tool of the device includes a base member wherein the base member additionally has secured thereto a magnet. The base member includes a mounting member that hingedly secures three tool elements. The first tool element is a stylus implement having an end configured to engage a touch screen. Another tool element hingedly secured is the forceps member having jaw portions configured to retrieve small items. A scraping member is hingedly secured to the base member having a second portion that is flat and operable to facilitate removal of material from a surface. The multi-function tool is encased in a housing wherein in a stored position the three tool elements are within the housing.

### FIELD OF THE INVENTION

The present invention relates generally to small tools, more specifically but not by way of limitation, a small handheld tool that includes a plurality of elements configure to assist a user in operation of a touchscreen, retrieve small items and scrape surface wherein the elements of the present invention are hingedly stored in a housing having open sides to provide access thereto.

### BACKGROUND

Multi-function tools are known in the art and the most common example is the traditional Swiss army knife. As is known in the art, these types of knifes include a plurality of alternate style blades and occasionally another type of element such as but not limited to scissors. These knives have served their purpose over the years but use thereof can be challenging for individuals who have long fingernails. The elements of these conventional knives are hingedly secured and access is obtained through engagement of an upper edge of the blade or element wherein that upper edge may have a notch or indentation to assist with engaging the blade or element to hinge outward from the case. The blades and elements only hinged in one direction and the access to elements can be difficult.

Many individuals have long fingernails and execution of daily tasks such as but not limited to operation of a touch screen on a smartphone, retrieving coins and other items can be cumbersome for those individuals with long fingernails. Long fingernails are a popular designer trend and there is a lack of tools that can help these individuals perform daily tasks such as but not limited to the aforementioned.

Accordingly, there is a need for a multi-functional tool that provides elements configured to assist with various daily tasks such as but not limited to smartphone operation, retrieval of credit cards and picking up coins.

### SUMMARY OF THE INVENTION

It is the object of the present invention to provide a multi-function tool that is configured to be handheld and execute a plurality of tasks wherein the present invention includes three hingedly secured tool members.

Another object of the present invention is to provide a handheld tool configured to assist a user with specific tasks wherein the three hingedly secured tools are mounted within a protective housing having open sides allowing access thereto.

A further object of the present invention is to provide a multi-function tool that is configured to be handheld and execute a plurality of tasks wherein of three hingedly secured tools is a stylus type of implement.

Yet a further object of the present invention is to provide a handheld tool configured to assist a user with specific tasks wherein an additional tool element of the present invention is a pair of forceps having opposable jaw members.

Still another object of the present invention is to provide a multi-function tool that is configured to be handheld and execute a plurality of tasks wherein another tool of the present invention is a scraping member.

An additional object of the present invention is to provide a handheld tool configured to assist a user with specific tasks wherein the present invention further includes a magnet.

Yet a further object of the present invention is to provide a multi-function tool that is configured to be handheld and execute a plurality of tasks wherein the device includes elements to operably coupled to items such as but not limited to purses.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of the present invention with the housing removed; and

FIG. 2 is a side view of the present invention with the tool elements stored within the housing.

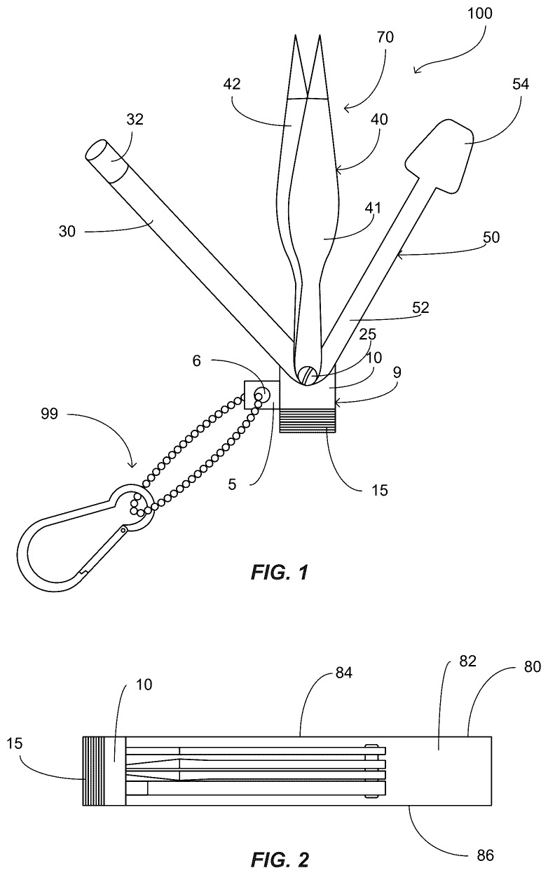

### DETAILED DESCRIPTION

Referring now to the drawings submitted herewith, wherein various elements depicted therein are not necessarily drawn to scale and wherein through the views and figures like elements are referenced with identical reference numerals, there is illustrated multi-function tool 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the multi-function tool 100 is configured to assist a user in executing a plurality of tasks. It should be understood within the scope of the present invention that the multi-function tool 100 could be provided in alternate colors and includes features such as but not limited to rubber coatings to improve comfort for the user during utilization of the multi-function tool 100. Additionally, it should be understood within the scope of the present invention that the multi-function tool 100 could be manufactured in alternate sizes.

The multi-function tool 100 includes a base member 10 wherein the base member 10 is manufactured from a durable rigid material such as but not limited to metal or plastic. The base member 10 includes a magnet 15 wherein the magnet 15 is secured to the first end 9 of the base member 10. The magnet 10 is secured to the base member 10 employing suitable durable techniques. The magnet 15 is utilized to retrieve any metallic item such as but not limited to coins. The base member 10 further includes a keeper 5 secured thereto wherein the keeper 5 includes an aperture 6 that can be operably coupled to a conventional chain and carabiner 99. This facilitates an ability to operably couple the multi-function tool 100 to a purse, backpack or similar item.

Opposedly located from the magnet 15 is mounting member 25. The mounting member 25 is journaled through the base member 10 and functions to hingedly secure the tool elements 70 to the base member 10. The mounting member 25 is configured to permit lateral motion of the tool elements 70 in both a left and right direction so as to permit the tool elements 70 to be hinged outward from the housing 80 on either side thereof through opening 82. The housing 80 includes open sides having openings 82 wherein the open sides allow a user to hingedly move the tool element 70 outward either side of the housing 80. The housing 80 provides coverage of the tool elements 70 in their stored position so as to inhibit snagging thereof. When the tool elements 70 are in their stored position, no portion thereof extends outwards from the openings 82 of the housing. The housing walls 84,86 are contiguously form with the base member 10 extending outward therefrom.

The multi-function tool 100 includes a stylus implement 30 hingedly secured with the mounting member 25. The stylus implement 30 is cylindrical and elongated in shape and is utilized to perform activities such as but not limited to depress buttons and engage a touchscreen of a smartphone. The stylus implement 30 includes end member 32 wherein the end member 32 is manufactured from a material that will facilitate improved operational engagement with a conventional touchscreen.

A forceps member 40 is hingedly secured to the base member 10 with the mounting member 25. The forceps member 40 includes opposable jaw portions 41,42 that are biasly opposed utilizing suitable techniques. During use the user will press the jaw portions 41,42 inwards towards each other so as to move the jaw portions 41,42 together capturing an item therebetween. It is contemplated within the scope of the present invention that the jaw portions 41,42 could be formed in alternate shapes having various designs of the ends thereof.

The multi-function tool 100 includes a scraping member 50 hingedly secured to the base member 10 utilizing mounting member 25. The scraping member 50 includes first portion 52 integrally formed with second portion 54. First portion 52 is rod shaped and the second portion 54 is flat in shape being modified square in form. The second portion 54 can be utilized to scrape a surface to provide removal of material therefrom. It should be understood within the scope of the present invention that the second portion 54 could be provided in alternate shapes and sizes but must remain flat in form to achieve the desired objective.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A multi-function tool comprising:
a base member, said base member having a first end and a second end, said base member being square in shape, said base member having a magnet secured to said first end,
a housing, said housing being contiguously formed with said base member extending outward from said second end of said housing, said housing having a first wall and a second wall with a void therebetween, said housing having openings on opposing sides thereof, said openings extending substantially along the housing;
a stylus implement, said stylus implement being hingedly mounted to said base member proximate said second end with a mounting member, said stylus implement being elongated and cylindrical in shape;
a forceps member, said forceps member being hingedly secured to said base member with said mounting member, said forceps member having a first jaw portion and a second jaw portion configured to be biased towards each other;
a scraping member, said scraping member being hingedly secured to said base member with said mounting member, said scraping member having a first portion and a second portion, said second portion being integrally formed with said first portion, said second portion being flat in form.

2. The multi-function tool as recited in claim 1, and further including a keeper, said keeper being formed on said base member, said keeper having an aperture formed therethrough.

3. The multi-function tool as recited in claim 2, said stylus implement having an end member, said end member configured to engage with a touchscreen.

4. The multi-function tool as recited in claim 3, wherein said stylus implement, said forceps member and said scraping member are in axial alignment within the housing in a stored position.

5. The multi-function tool as recited in claim 4, wherein said stylus implement, said forceps member and said scraping member are movable through the openings of said housing on opposing sides of the housing in a first direction and a second direction.

6. The multi-function tool as recited in claim 5, wherein said first portion of said scraping member is rod-shaped.
